(19) United States
(12) Patent Application Publication
(10) Pub. No.: US 2025/0284976 A1
(43) Pub. Date: Sep. 11, 2025

(54) ELECTRONIC DEVICE PROVIDING ARTIFICIAL INTELLIGENCE SERVICE AND CONTROL METHOD THEREFOR

(71) Applicant: SAMSUNG ELECTRONICS CO., LTD., Suwon-si (KR)

(72) Inventors: Sungho LEE, Suwon-si (KR); Joonwoo KIM, Suwon-si (KR); Hyunjun KIM, Suwon-si (KR); Venkatraman Ganeshan IYER, Suwon-si (KR); Hyunjin YI, Suwon-si (KR)

(73) Assignee: SAMSUNG ELECTRONICS CO., LTD., Suwon-si (KR)

(21) Appl. No.: 19/217,730

(22) Filed: May 23, 2025

Related U.S. Application Data
(63) Continuation of application No. PCT/KR2023/016670, filed on Oct. 25, 2023.

(30) Foreign Application Priority Data
Dec. 1, 2022 (KR) 10-2022-0166032

(51) Int. Cl. G06N 3/10

(52) U.S. Cl. CPC G06N 3/10

(57) ABSTRACT

Provided is an electronic device including a communication interface, a memory for storing a plurality of neural network models and a plurality of profile information corresponding to the plurality of neural network models, and a plurality of processors. Each profile information of a plurality of profile information includes information on a neural network model for performing a task corresponding to each task request and resource information of the electronic device that is required for each processor of the plurality of processors to perform the task using the neural network model.

### CROSS REFERENCE TO RELATED APPLICATIONS

This application is a bypass continuation application of International Application No. PCT/KR2023/016670, filed on Oct. 25, 2023, which is based on and claims priority to Korean Patent Application No. 10-2022-0166032, filed on Dec. 1, 2022, the disclosures of which are incorporated by reference herein in their entireties.

### BACKGROUND

### 1. Field

The disclosure relates to an electronic device providing an artificial intelligence service and a control method therefor. More particularly, the present disclosure relates to an electronic device providing a local network-based artificial intelligence service and a control method therefor.

### 2. Description of Related Art

In recent years, various home appliances have been providing internet of things (IoT) services as electronic technology has advanced. A conventional home appliance may use data and programs stored therein to provide only limited services. However, a recent IoT-based home appliance may provide a user with more diverse and expanded services by being linked with another home appliance to share data and by using programs stored in another home appliance.

In particular, the recent home appliance may provide an artificial intelligence-based service, thus providing a higher-level service, such as recognizing a user voice to thus perform an operation or provide a customized service to the user, beyond the limited services provided by the conventional home appliances.

The artificial intelligence-based service may require the home appliance to have a high specification for enabling the home appliance to perform a task required for the service. This requirement/demand may lead to a problem of increasing a manufacturing cost of the home appliance. In particular, a small home appliance (e.g., robot cleaner or a speaker) may have difficulty in including a high-specification component, which results in a limitation in providing the artificial intelligence-based service.

Accordingly, an electronic device performing an artificial intelligence-based task, i.e., task required for the artificial intelligence-based service, on behalf of the IoT-based home appliance has been recently used together with the IoT-based home appliance. In detail, the electronic device may be requested, by the IoT-based home appliance, to perform the artificial intelligence-based task on behalf of the IoT-based home appliance, then perform the task based on a high specification of the electronic device, and transmit a task result to the IoT-based home appliance. In this way, the IoT-based home appliance may provide various artificial intelligence-based services to the user without having the high specification. The electronic device performing the artificial intelligence-based task on behalf of the IoT-based home appliance may include, for example, an edge AI service server.

### SUMMARY

According to an aspect of the disclosure, there is provided an electronic device including: a memory configured to store at least one neural network model and a plurality of profile information including least one profile information corresponding to each of the at least one neural network model; and a plurality of processors, wherein each profile information of the plurality of profile information includes information on a neural network model for performing a task corresponding to each task request and resource information of the electronic device that is required for each processor of the plurality of processors to perform the task using the neural network model, and wherein a first processor among the plurality of processors is configured to: receive a first task request, based on the first task request being received, identify a first neural network model corresponding to the received first task request from the at least one neural network model stored in the memory, identify at least one first profile information corresponding to the identified first neural network model from the plurality of profile information stored in the memory, identify, from the plurality of processors, a second processor to perform, by using the identified first neural network model, a first task corresponding to the first task request based on the identified at least one first profile information and a current resource state of the electronic device, and control the identified second processor to perform, by using the identified first neural network model, the first task.

The first processor may be configured to: identify a quality of service (Qos) requirement corresponding to the first task request, identify at least one second profile information satisfying the identified Qos requirement from the plurality of profile information, and identify, from the plurality of processors, the second processor to perform, by using the identified first neural network model, the first task based on the identified at least one second profile information and a current resource of the electronic device.

The first processor may be configured to: identify, from the plurality of processors, at least one processor available to perform, by using the first neural network model, the first task based on the identified at least one first profile information, identify the current resource state of the electronic device by identifying whether each of the at least one processor is performing a second task other than the first task, and identify, from the at least one processor, the second processor to perform the first task based on the identified current resource state and the identified at least one first profile information.

The first processor may be configured to: identify a processor that is not performing the second task from the identified at least one processor as the second processor to perform the first task.

The each profile information of the plurality of profile information further may include time information required for the each processor of the plurality of processors to perform, by using the neural network model, the task, and wherein the first processor may be configured to: identify a performance completion time of the first task for the each processor of the at least one processor based on the identified at least one first profile information, and identify, from the plurality of processors, the second processor to perform the first task based on the identified performance completion time.

The first processor may be configured to: identify the neural network model for performing each task performed by the electronic device, identify at least one framework used to execute each neural network model for each of the identified neural network models, identify, from the plurality of processors, at least one processor for executing the identified at least one framework, obtain information on a resource of the electronic device that is required while the identified at least one processor performs the task, and generate each profile information based on information on the at least one framework, information on each of the at least one processor, and information on the resource of the electronic device.

The first processor may be configured to: identify a Qos requirement corresponding to the task request, based on the second processor completes task performance using the neural network model, identify whether the task performance of the second processor satisfies the QOS requirement, and based on the task performance of the second processor being identified as satisfying the Qos requirement, set a reward value to the identified at least one first profile information corresponding to the second processor among the identified at least one first profile information.

The electronic device may further comprise a communication interface and be connected to the external electronic device via a local network using the communication interface.

According to an aspect of the disclosure, there is provided a control method for an electronic device, the control method including: based on a first task request, identifying a first neural network model corresponding to the received first task request from at least one neural network model stored in a memory of the electronic device; identifying at least one first profile information corresponding to the identified first neural network model from a plurality of profile information stored in the memory, wherein the plurality of items of profile information include at least one profile information corresponding to the at least one neural network model; identifying, from a plurality of processors, a second processor to perform, by using the identified first neural network model, a first task corresponding to the first task request based on the identified at least one first profile information and a current resource state of the electronic device; and controlling the identified second processor to perform, by using the identified first neural network model, the first task, wherein each profile information of the plurality of profile information includes information on a neural network model for performing a task corresponding to each task request and resource information of the electronic device that is required for each processor of the plurality of processors to perform the task using the neural network model.

The identifying of the at least one first profile information may comprise identifying a quality of service (QOS) requirement corresponding to the first task request is identified, and identifying at least one second profile information satisfying the identified QOS requirement from the plurality of profile information, and wherein the identifying of the second processor may comprise identifying, from the plurality of processors, the second processor to perform, by using the identified first neural network model, the first task based on the identified at least one second profile information and a current resource of the electronic device.

The identifying of the second processor may include identifying, from the plurality of processors, at least one processor available to perform, by using the first neural network model, the first task based on the identified at least one first profile information, identifying the current resource state of the electronic device by identifying whether each of at least one processor is performing a second task other than the first task, and identifying, from the at least one processor, the second processor to perform the first task based on the identified current resource state and the identified at least one first profile information.

The identifying of the second processor may comprise identifying a processor that is not performing the second task from the identified at least one processor as the second processor to perform the first task.

The each profile information of the plurality of profile information may further include time information required for the each processor of the plurality of processors to perform, by using the neural network model, the task, and wherein the identifying of the second processor may comprise identifying a performance completion time of the first task for the each processor of the at least one processor based on the identified at least one first profile information, and identifying, from the plurality of processors, the second processor to perform the first task based on the identified performance completion time.

The control method may include identifying the neural network model for performing each task performed by the electronic device; identifying each of at least one framework used to execute each neural network model for each of the identified neural network models; identifying, from the plurality of processors, at least one processor for executing the identified at least one framework; obtaining information on a resource of the electronic device that is required while each of the identified at least one processor performs the task; and generating each profile information based on information on the at least one framework, information on each of the at least one processor, and information on the resource of the electronic device.

The control method may include identifying a quality of service (Qos) requirement corresponding to the task request, based on the second processor completes the task performance using the neural network model, identifying whether the task performance of the second processor satisfies the QOS requirement; and based on the task performance of the second processor may be identified as satisfying the QOS requirement, setting a reward value to first profile information corresponding to the second processor among the identified at least one of first profile information.

### BRIEF DESCRIPTION OF THE DRAWINGS

The above and other aspects and/or features of one or more embodiments of the present disclosure will be more apparent from the following description taken in conjunction with the accompanying drawings, in which:

FIG. 1 is an example diagram of an electronic device according to an embodiment of the present disclosure;

FIG. 2 is a schematic block diagram of the electronic device according to an embodiment of the present disclosure;

FIG. 3 is an example diagram showing a plurality of profile information according to an embodiment of the present disclosure;

FIG. 4 is an example diagram showing identifying a processor to perform a task based on the profile information and a current resource state of the electronic device according to an embodiment of the present disclosure;

FIG. 5 is an example diagram showing selecting the processor to perform the task based on a quality of service requirement according to an embodiment of the present disclosure;

FIG. 6 is an example diagram showing selecting the processor to perform the task based on a resource state of the electronic device according to an embodiment of the present disclosure;

FIGS. 7A, 7B, and 7C are exemplary diagrams showing selecting the processor to perform the task based on a time required for the processor to perform the task according to an embodiment of the present disclosure;

FIG. 8 is an exemplary diagram showing a method for selecting a second processor based on a reward value according to an embodiment of the present disclosure; and

FIG. 9 is a flowchart schematically showing a control method for an electronic device according to an embodiment of the present disclosure.

### DETAILED DESCRIPTION

The present disclosure may be variously modified and have several embodiments, and specific embodiments of the present disclosure are thus shown in the drawings and described in detail in the detailed description. However, it should be understood that the scope of the present disclosure is not limited to the specific embodiments, and includes various modifications, equivalents, and/or alternatives according to the disclosure. Throughout the embodiments of the present accompanying drawings, similar components are denoted by similar reference numerals.

In describing the present disclosure, omitted is a detailed description of a case where it is decided that the detailed description of the known functions or configurations related to the present disclosure may unnecessarily obscure the gist of the present disclosure.

In addition, the following embodiments may be modified in several different forms, and the scope and spirit of the present disclosure are not limited to the following embodiments. Rather, these embodiments are provided to make the present disclosure thorough and complete, and completely convey the spirit of the present disclosure to those skilled in the art.

Terms used in the present disclosure are used only to describe the specific embodiments rather than limiting the scope of the present disclosure. Here, a term of a singular number includes its plural number unless explicitly interpreted otherwise in the context.

In the present disclosure, an expression “have”, “may have”, “include”, “may include” or the like, indicates the presence of a corresponding feature (for example, a numerical value, a function, an operation, or a component such as a part), and does not exclude the presence of an additional feature.

In the present disclosure, an expression “A or B”, “at least one of A and/or B”, “one or more of A and/or B” or the like, may include all possible combinations of items enumerated together. For example, “A or B”, “at least one of A and B” or “at least one of A or B” may indicates all of 1) a case where at least one A is included, 2) a case where at least one B is included, or 3) a case where both of at least one A and at least one B are included.

The expressions “first”, “second” and the like used in the present disclosure may indicate various components regardless of a sequence and/or importance of the components. These expressions are only used in order to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through still another component (for example, a third component).

On the other hand, if any component (for example, the first component) is mentioned to be “directly coupled” or “directly connected to” another component (for example, the second component), it should be understood that still another component (for example, the third component) is not present between any component and another component.

An expression “configured (or set) to” used in the present disclosure may be replaced with an expression “suitable for”, “having the capacity to”, “designed to”, “adapted to”, “made to”, or “capable of” based on a situation. The expression “configured (or set) to” may not necessarily indicate “specifically designed to” in hardware.

Rather, an expression “a device configured to” in some contexts may indicate that the device may “perform˜” together with another device or component. For example, “a processor configured (or set) to perform A, B and C” may indicate a dedicated processor (for example, an embedded processor) that performs a corresponding operation or a generic-purpose processor (for example, a central processing unit (CPU) or an application processor) that performs the corresponding operation by executing at least one software program stored in a memory device.

In the embodiments, a “module” or a “˜er/or” may perform at least one function or operation, and be implemented by hardware, software, or a combination of hardware and software. In addition, a plurality of “modules” or a plurality of “˜ers/ors” may be integrated with each other in at least one module and implemented by at least one processor except for a “module” or an “˜er/or” that needs to be implemented in specific hardware.

Meanwhile, various elements and regions in the drawings are schematically shown. Therefore, the spirit of the present disclosure is not limited to relative sizes or intervals shown in the accompanying drawings.

Hereinafter, the embodiments of the present disclosure are described in detail with reference to the accompanying drawings so that those skilled in the art to which the present disclosure pertains may easily practice the present disclosure.

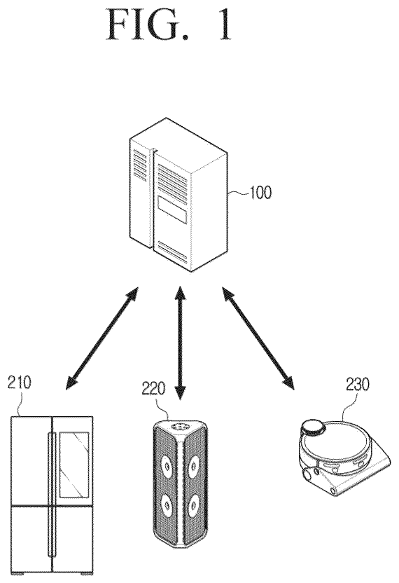

FIG. 1 is an example diagram of an electronic device 100 according to an embodiment of the present disclosure.

Referring to FIG. 1, the electronic device 100 according to an embodiment of the present disclosure may be linked with a plurality of external electronic devices 210, 220, and 230. In detail, the electronic device 100 may perform communication with the plurality of external electronic devices 210, 220, and 230, and to perform specific tasks by the plurality of external electronic devices 210, 220, and 230. For example, the electronic device 100 may be requested to perform voice recognition on a user voice acquired by a speaker 220, or requested to perform object recognition in an image acquired by a robot cleaner 230. In this way, the electronic device 100 may be requested to perform various tasks of the plurality of external electronic devices 210, 220, and 230, and to transmit results of the performed tasks.

In particular, the electronic device 100 according to an embodiment of the present disclosure may perform an artificial intelligence-based task. Here, the artificial intelligence-based task may include a task performed using a neural network model.

As an example, the task of recognizing an object in the image or classifying a plurality of images using a pre-trained convolutional neural network (CNN) model stored in the electronic device 100 may correspond to the artificial intelligence-based task. The electronic device 100 may be requested by the plurality of external electronic devices 210, 220, and 230 to perform the artificial intelligence-based task that is difficult to be performed by the plurality of external electronic devices 210, 220, and 230. The plurality of external electronic devices 210, 220, and 230 (hereinafter, referred to as the external electronic devices 200) may include various electronic devices such as a vacuum cleaner and a refrigerator that provide an internet of things (IoT) service, and it may be difficult for the external electronic devices 200 to perform the artificial intelligence-based tasks on their own due to limitations of resources (or specifications) of the external electronic devices 200. Accordingly, the plurality of external electronic devices 200 may request the electronic device 100 to perform, on their behalf, a task required to provide an artificial intelligence service, among services provided to a user by the respective external electronic devices 200. In addition, the electronic device 100 may perform the requested task and then transmit the task result to the external electronic devices 200.

In this way, the plurality of external electronic devices 200 may provide the user with diverse and expanded services.

The electronic device 100 according to an embodiment of the present disclosure may be implemented as a server device. In particular, the electronic device 100 may be implemented as an edge AI server device, a cloud server device, or the like that provides the artificial intelligence-based service.

Meanwhile, the electronic device 100 may perform the plurality of tasks simultaneously. As an example, the electronic device 100 may perform the plurality of tasks simultaneously if the electronic device 100 is requested to perform the tasks simultaneously from the different external electronic devices 200. In this case, the electronic device 100 may be overloaded in case of performing the plurality of artificial intelligence-based tasks simultaneously even if the electronic device 100 has richer resources (or higher specifications) than the external electronic devices 200. For example, a task speed of the electronic device 100 may slow down or the task may be interrupted due to the overload of electronic device 100.

Here, the electronic device 100 may prevent the overload if the electronic device 100 sequentially performs the plurality of requested tasks. However, if the plurality of tasks are always performed separately and sequentially even though the plurality of tasks are capable of being performed simultaneously using a spare resource of the electronic device 100 based on a task type, the later the external electronic devices 200 request task performance, the longer it takes to receive a task performance result based on a current task performance status of the electronic device 100 (for example, whether the electronic device is currently performing the task). This problem may lead to a problem in which a service provision time is changed based on the task performance status of the electronic device 100 although the external electronic devices 200 are required to immediately provide the user with the service based on a service type.

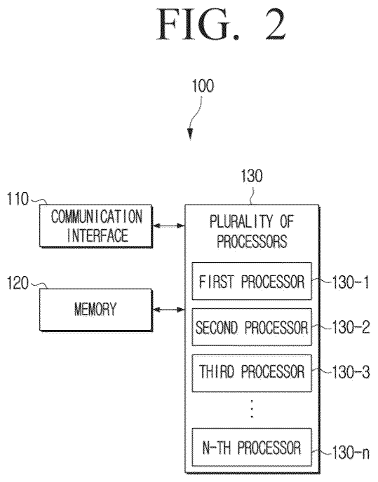

Therefore, if the electronic device 100 is requested to perform the plurality of tasks, it is necessary to determine whether to perform the tasks sequentially or simultaneously based on the task type. That is, it is necessary to adjust a schedule appropriately for the plurality of tasks. For this purpose, the electronic device 100 according to an embodiment of the present disclosure may generate profile information on the plurality of tasks requested by the plurality of external electronic devices 200 linked with the electronic device 100, and design an appropriate performance method for the plurality of tasks if the plurality of task requests are received based on the generated profile information. Hereinafter, an embodiment of the present disclosure is described in detail with reference to FIGS. 2 to 9.

FIG. 2 is a schematic block diagram of the electronic device 100 according to an embodiment of the present disclosure.

Referring to FIG. 2, the electronic device 100 according to an embodiment of the present disclosure may include a communication interface 110, a memory 120, and a plurality of processors 130.

The communication interface 110 may communicate with the plurality of external electronic devices 200 by using various communication methods. The communication interface 110 may receive a request for the task performance for the AI service from the plurality of external electronic devices 200. In addition, the communication interface 110 may transmit, to the external electronic devices 200, a task performance result of the electronic device 100 acquired based on the task performance request of the external electronic devices 200. Meanwhile, the communication interface 110 may establish a communication connection with the external electronic devices 200 via a third-party device (e.g., repeater, hub, access point, or gateway).

The communication interface 110 may include various communication modules for performing the communication with the external electronic devices 200. As an example, the communication interface 110 may include a wireless communication module, and include at least one of, for example, wireless fidelity (Wi-Fi), Bluetooth, Bluetooth low energy (BLE), or

### Zigbee.

Meanwhile, according to an embodiment of the present disclosure, the electronic device 100 may be connected to the external electronic devices 200 via a local network using the communication interface 110.

In detail, the electronic device 100 and the external electronic devices 200 may be connected to each other via the same communication network within a predetermined region. Here, the predetermined region may be a concept that includes the same physical space, such as a house, a school, or a building. In addition, the predetermined region may be a concept that includes a geographical region, such as an area within a predetermined range. The electronic device 100 and the external electronic devices 200 may be connected to each other via a communication network set in the predetermined region where the electronic device 100 and the external electronic devices 200 are disposed by using their respective communication interfaces (that is, the communication interface 110 of the electronic device 100 and communication interfaces of the external electronic devices), and may transmit and receive information.

The memory 120 may store an operating system (OS) for controlling overall operations of components included in the electronic device 100, and instructions or data related to the components of the electronic device 100.

In particular, the memory 120 may store information on the plurality of external electronic devices 200 linked with the electronic device 100. Here, the information on the plurality of external electronic devices 200 may include identification information of each of the external electronic devices 200 linked with the electronic device 100. As an example, the memory 120 may store the identification information of at least one external electronic device 200 connected to the electronic device 100 via the local network. Here, the identification information may include the Mac Address, serial number, or the like of the external electronic devices 200.

In addition, the memory 120 may store at least one neural network model and a plurality of profile information. The plurality of profile information include at least one profile information corresponding to each of the at least one neural network model. For example, the memory 120 may store the plurality of neural network models and a plurality of profile information 11 and 12 corresponding to the plurality of neural network models. Each of the plurality of profile information 11 and 12 may include information on the neural network model for performing the task corresponding to each task request and resource information of the electronic device 100 that is required for each of the plurality of processors 130 to perform the task using the neural network model.

Hereinafter, each type of task is matched with a single type of neural network, and each neural network may be associated with plurality of the first profile information. Based on the plurality of profile information, the electronic device may identify the most suitable processor for performing the task.

In detail, the memory 120 may store the plurality of neural network models used to perform the artificial intelligence-based task. Here, the plurality of neural network models may be neural network models used to perform the tasks required by the external electronic devices 200. Each neural network model may be a model pre-trained on the basis of the task required by each of the external electronic devices 200 and the task result.

That is, the memory 120 may store the plurality of models trained differently based on the external electronic devices 200 or the task type required by the external electronic devices 200, even if the models are of the same type. For example, the plurality of external electronic devices 200 may include the refrigerator and the vacuum cleaner. If the refrigerator provides a service for identifying a type of food ingredient in an image acquired by the refrigerator, and the vacuum cleaner provides a service for identifying a type of obstacle in an image acquired by the vacuum cleaner, the memory 120 may store the CNN model trained to identify the food ingredient in the image and the CNN model trained to identify the type of obstacle in the image, respectively.

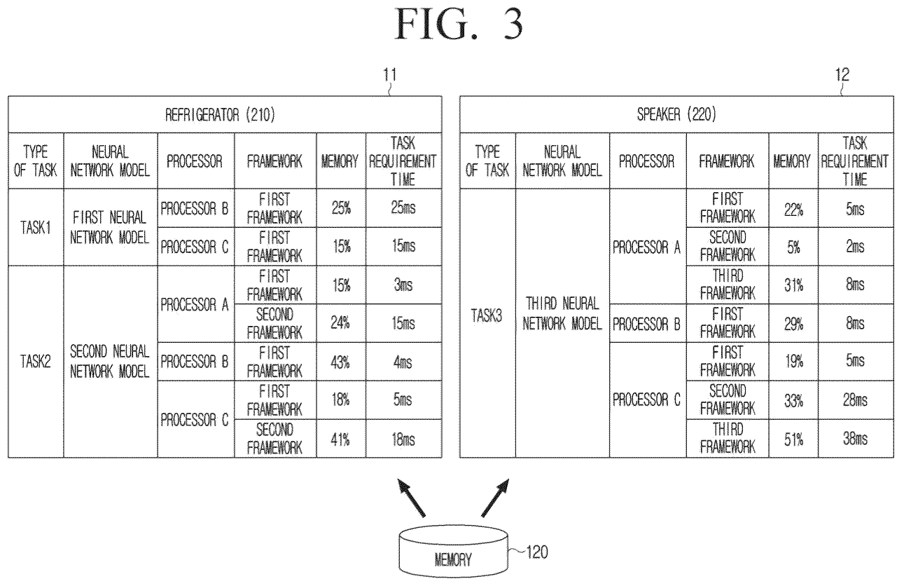

FIG. 3 is an example diagram showing the plurality of profile information 11 and 12 according to an embodiment of the present disclosure.

Meanwhile, the profile information 11 may include the resource information of the electronic device 100 that is used or required to perform each of the artificial intelligence-based tasks. In detail, the resource information may include a type of processor performing the task, a type of neural network model, a type of framework, a task performance time, or the like. For example, the framework may be a software for training and inference of the neural network model.

Referring to FIG. 3, for a refrigerator 210 among the plurality of external electronic devices 200 linked to the electronic device 100, in case of Task 1 of the refrigerator 210, a processor B 130-B and a processor C 130-C among the plurality of processors 130 may respectively perform Task 1 using a first neural network model through a first framework. Here, the processor B 130-B may require 25 milliseconds (ms) in case of performing Task 1 using the first neural network model through the first framework, whereas a processor C 130-C may require 15 ms in case of performing Task 1 using the first neural network model through the first framework.

That is, the plurality of profile information 11 and 12 stored in the memory 120 may be classified based on the plurality of external electronic devices 200 linked with the electronic device 100 and the task type requested by each of the plurality of external electronic devices 200.

Meanwhile, the memory 120 embedded in the electronic device 100 may be implemented as at least one of a volatile memory (for example, a dynamic random access memory (DRAM), a static RAM (SRAM), or a synchronous dynamic RAM (SDRAM)), or a non-volatile memory (for example, an one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash or a NOR flash), a hard drive, or a solid state drive (SSD)).

In addition, the memory 120 detachable from the electronic device 100 may be implemented in the form of a memory card (for example, a compact flash (CF), a secure digital (SD), a micro secure digital (Micro-SD), a mini secure digital (Mini-SD), an extreme digital (xD), or a multi-media card (MMC)), or an external memory capable of being connected to a universal serial bus (USB) port (for example, a USB memory).

The plurality of processors 130 according to an embodiment of the present disclosure may perform overall control operations of the electronic device 100.

The plurality of processors 130 may include one or

more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. One or more processors 130 may control one of other components of the electronic device 100 or any combination thereof, and perform an operation related to the communication or data processing. The plurality of processors 130 may execute one or more programs or instructions stored in the memory 120. For example, the plurality of processors 130 may perform a method according to an embodiment of the present disclosure by executing one or more instructions stored in the memory 120.

If the method according to an embodiment of the present disclosure includes a plurality of operations, the plurality of operations may be performed by one processor or may be performed by the plurality of processors 130. For example, a first operation, a second operation, and a third operation may be performed using the method according to an embodiment. In this case, the first operation, the second operation, and the third operation may all be performed by a first processor.

Alternatively, the first operation and the second operation may be performed by the first processor (for example, a general-purpose processor), and the third operation may be performed by a second processor (for example, an artificial intelligence-only processor).

The plurality of processors 130 may be implemented as one or more multi-core processors (multicore processors) including multicores (e. g., homogeneous multicores or heterogeneous multicores). If the plurality of processors 130 are implemented as the multicore processors, each of the multicores included in the multicore processor may include a processor internal memory such as a cache memory or an on-chip memory, and a common cache shared by the multicores may be included in the multicore processor. In addition, each of the multicores (or some of the multicores) included in the multicore processor may independently read and perform a program instruction for implementing the method according to an embodiment of the present disclosure, or all (or some) of the multicores may be linked to each other to read and perform the program instruction for implementing the method according to an embodiment of the present disclosure.

If the method according to an embodiment of the present disclosure includes the plurality of operations, the plurality of operations may be performed by one core among the multicores included in the multicore processor, or may be performed by the multicores. For example, the first operation, the second operation, and the third operation may be performed using the method according to an embodiment. In this case, the first operation, the second operation, and the third operation may all be performed by a first core included in the multicore processor, or the first operation and the second operation may be performed by the first core included in the multicore processor, and the third operation may be performed by a second core included in the multicore processor.

In the embodiments of the present disclosure, the processor 130 may indicate a system-on-chip (SoC) in which one or more processors and other electronic components are integrated with each other, a single-core processor, the multicore processor, or the core included in the single-core processor or the multicore processor. Here, the core may be implemented as the CPU, the GPU, the APU, the MIC, the DSP, the NPU, the hardware accelerator, the machine learning accelerator, or the like. However, the embodiments of the present disclosure are not limited thereto.

According to an embodiment of the present disclosure, a first processor 131 among the plurality of processors 130 may identify the neural network model corresponding to the received task request from the plurality of neural network models stored in the memory 120 if the task request is received from the external electronic devices 200 via the communication interface 110. The first processor 131 may be set to any one of the plurality of processors 130 as a processor among the plurality the of processors 130 that receives the task request from t external electronic devices 200 and performs an operation of selecting a processor to perform the task corresponding to the received task request. The first processor 131 may also be referred to as a main processor.

The first processor 131 may receive the task request from the external electronic devices 200 via the communication interface 110. In detail, the first processor 131 may be requested to perform the task required for the artificial intelligence-based service provided by the external electronic devices 200 via the communication interface 110. Here, the first processor 131 may receive task type information and data necessary to perform the task from the external electronic devices 200 via the communication interface 110 together with the task performance request.

For example, the speaker 220 may request a task to perform the voice recognition on the user voice received by the electronic device 100 if the external electronic device 200 is the speaker 220, and the speaker 220 receives the user voice and then provides a response service for the received user voice. Here, the first processor 131 may be requested to perform the voice recognition on the user voice and user voice information received through the speaker 220 by the speaker 220 via the communication interface 110.

Meanwhile, the first processor 131 may receive the task request from the external electronic devices 200 and then identify the neural network model corresponding to the received task request from the plurality of neural network models stored in the memory 120. The neural network model corresponding to the task request may be a neural network model used by the plurality of processors to perform the tasks based on the task requests. The first processor 131 may identify the task type corresponding to the received task request, and identify the neural network model required to perform the task based on the identified task type from the plurality of neural network models stored in the memory 120.

To describe the above example again, the neural network model corresponding to the task request may be a model used to perform the voice recognition if the first processor 131 is requested to perform the voice recognition on the user voice by the speaker 220 via the communication interface 110. Here, the first processor 131 may identify a neural network model (e.g., speech to text (STT) model or language model (LM)) used on the voice recognition from the plurality of neural network models stored in the memory 120.

Meanwhile, the first processor 131 may identify the neural network model required for the task performance that is requested by the external electronic devices 200 by using the plurality of profile information stored in the memory 120. In detail, the first processor 131 may acquire at least one profile information corresponding to the external electronic devices 200 among the plurality of profile information stored in the memory 120, and select the profile information corresponding to the received task request from the acquired at least one profile information. In addition, the first processor 131 may identify the neural network model used to perform the task corresponding to the received task request from the plurality of neural network models stored in the memory 120 based on the selected profile information.

The first processor 131 may identify the neural network model corresponding to the task request, and then identify, from the plurality of processors 130, the processor to perform the task corresponding to the task request using the identified neural network model on the basis of the plurality of profile information corresponding to the identified neural network model stored in the memory 120 and a current resource state of the electronic device 100.

The first processor 131 may select the plurality of profile information corresponding to the neural network model from the plurality of profile information stored in the memory 120. Here, the plurality of profile information corresponding to the neural network model may be a plurality of profile information corresponding to the task corresponding to the task request received by the first processor 131 via the communication interface 110.

As an example, referring to FIG. 3, the first processor 131 may be requested by the refrigerator 210 to perform a task (hereinafter, referred to as Task 1) of identifying the type of food ingredient in the image. In this case, the first processor 131 may identify the neural network model (or the neural network model trained to identify the type of food, that is, the first neural network model) used to identify the type of food ingredient from the plurality of neural network models stored in the memory 120. In addition, the first processor 131 may acquire the plurality of profile information corresponding to the neural network model used to identify the type of food ingredient.

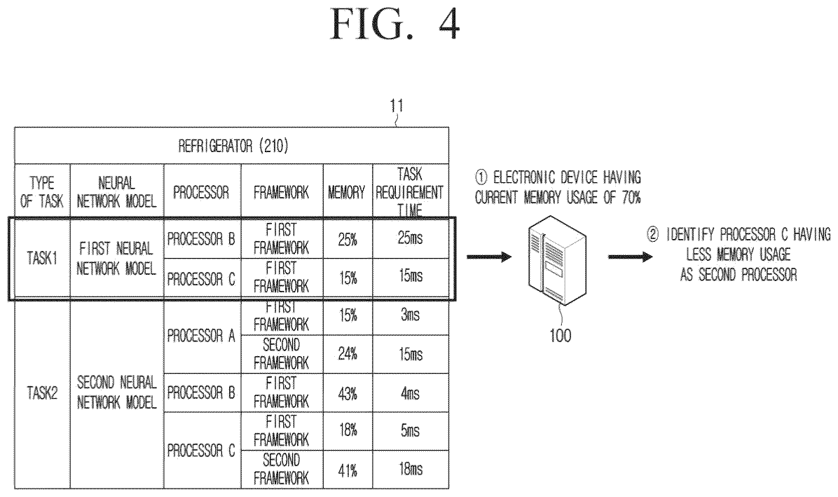

FIG. 4 is an example diagram showing identifying the processor to perform the task on the basis of the profile information and the current resource state of the electronic device 100 according to an embodiment of the present disclosure.

In addition, the first processor 131 may select the processor to perform the task requested by the external electronic devices 200 based on the plurality of profile information and the current resource state of the electronic device 100. The processor selected by the first processor 131 may be referred to as a task processor in that the corresponding processor performs the task requested by the external electronic devices 200, or may be referred to as a second processor to be distinguished from the first processor 131. Hereinafter, for convenience of describing the present disclosure, the second processor refers to a processor to perform the requested task.

In detail, the first processor 131 may identify, from the plurality of processors 130, at least one processor available to perform the task requested by the external electronic device 200 based on the plurality of profile information. In addition, the first processor 131 may select one second processor to perform the tasks requested by the external electronic devices 200 from at least one processor identified based on the current resource state of the electronic device 100. Here, the current resource status may refer to the resources currently available in the electronic device 100. For example, the current resource state of the electronic device 100 may include an available cache of the electronic device 100 or a capacity of the memory 120, whether each processor is available to perform the task, or the like.

As an example, referring to FIG. 4, the first processor 131 may identify, from the plurality of neural network models, the first neural network model trained to perform the task of identifying the type of food ingredient in the image based on the profile information for the refrigerator 210 if the first processor 131 is requested by the refrigerator 210 to perform the task (i.e., Task 1) of identifying the type of food ingredient in the image.

In addition, the first processor 131 may identify the processor B 130-B and the processor C 130-C as the processors available to perform Task 1 using the first neural network model based on the profile information corresponding to the first neural network model (or Task 1). In addition, the first processor 131 may select, from the processor B 130-B and the processor C 130-C, the second processor to perform Task 1 on the basis of the current resource state of the electronic device 100. In detail, if a current usage of the memory 120 included in the electronic device 100 is 70%, the first processor 131 may identify an amount of the memory 120 that the processor B 130-B or the processor C 130-C is to use to perform Task 1 using the first neural network model based on the profile information. Here, 25% of the memory 120 may be used if the processor B 130-B performs Task 1, and 15% of the memory 120 may be used if the processor C 130-C performs Task 1. In this case, the first processor 131 may select the processor C 130-C as the processor to perform Task 2 on the basis of the current resource state (i.e., the current usage of the memory 120 included in the electronic device 100 is 70%).

If the processor B 130-B performs Task 1, the spare resource of the electronic device 100 may be insufficient because 95% of the memory 120 included in the electronic device 100 is used. As a result, the electronic device 100 may not be able to perform another task other than Task 1 or the electronic device 100 may be overloaded. Therefore, the first processor 131 may select the processor C 130-C, which uses less resources of the electronic device 100, as the second processor.

In addition, according to an embodiment of the present disclosure, the first processor 131 may identify the second processor to perform the requested task on the basis of the profile information and the resource state of the electronic device 100 at a time point at which the task performance is requested by the external electronic devices 200, and then control the identified second processor to perform the task using the identified neural network model.

In detail, the first processor 131 may transmit, to the second processor, task type information of data received from the external electronic devices 200, the data necessary to perform the task, or the like. Referring back to FIG. 4, the first processor 131 may transmit the image received from the refrigerator 210 to the processor C 130-C and request the processor C 130-C to identify a food ingredient in the image.

In addition, the first processor 131 may receive, from the processor C 130-C, information on the food ingredient in the image identified as Task 1 is performed and then transmit the information to the refrigerator 210 via the communication interface 110 or may request the processor C 130-C to directly transmit the information to the refrigerator 210 via the communication interface 110.

Meanwhile, according to an embodiment of the present disclosure, the first processor 131 may identify a quality of service (Qos) requirement corresponding to the task request, select a plurality of second profile information satisfying the identified quality of service requirement from the plurality of first profile information, identify, from the plurality of processors 130, the second processor to perform the task using the identified neural network model on the basis of the selected plurality of second profile information and a current resource of the electronic device 100.

In detail, the first processor 131 may identify the quality of service requirement for the requested task if the first processor 131 is requested by the external electronic devices 200 to perform the task. The quality of service requirement may be pre-stored in the memory 120 of the electronic device 100. As an example, the first processor 131 may receive information on the external electronic devices 200 if the electronic device 100 and the external electronic devices 200 are initially linked with each other, or if the devices are initially connected to each other via the local network using the communication interface 110. The identification information of the external electronic devices 200 described above may correspond to the information on the external electronic devices 200. Here, the first processor 131 may receive information on the task that the external electronic devices 200 are to request from the electronic device 100 (i.e., information on the task that the electronic device 100 is to perform for the external electronic devices 200).

The task information may include the type of task requested by the external electronic devices 200, that is, the task that the electronic device 100 is to perform for the external electronic devices 200, information on the neural network model used for the task, or the like. In addition, the first processor 131 may receive the quality of service requirement for each task from the external electronic device 200.

The quality of service requirement may be information on a condition that the electronic device 100 needs to satisfy in performing each task requested by the external electronic devices 200. As an example, a time required for the electronic device 100 to perform the requested task and then transmit the task result, an accuracy rate of the task result, or the like may correspond to the quality of service requirement.

Meanwhile, the quality of service requirement may be changed based on time, condition, or user, even for the same task. Therefore, the first processor 131 may also receive the quality of service requirement for the requested task performance from the external electronic devices 200 if the first processor 131 is requested by the external electronic devices 200 to perform the task.

For example, the external electronic device 200 may be the speaker 220, and the speaker 220 may request the voice recognition on the user voice from the electronic device 100. In this case, the speaker 220 may set a different time limit for receiving a voice recognition result based on a subject of the user voice or a time of requesting the voice recognition. In detail, if the speaker 220 requests the voice recognition to the electronic device 100 in the morning, the speaker 220 may set the quality of service requirement in which the electronic device 100 transmits the voice recognition result within 3 ms after receiving the voice recognition request. On the other hand, if the speaker 220 requests the voice recognition to the electronic device 100 at dawn, the speaker 220 may set the quality of service requirement in which the electronic device 100 transmits the voice recognition result within 4 ms after receiving the voice recognition request.

The first processor 131 may identify the quality of service requirement corresponding to the task request received from the external electronic devices 200, and then select at least one profile information satisfying the identified quality of service requirement from the plurality of first profile information corresponding to the received task. Hereinafter, for convenience of describing the present disclosure, the second profile information refers to at least one profile information selected on the basis of the quality of service requirement.

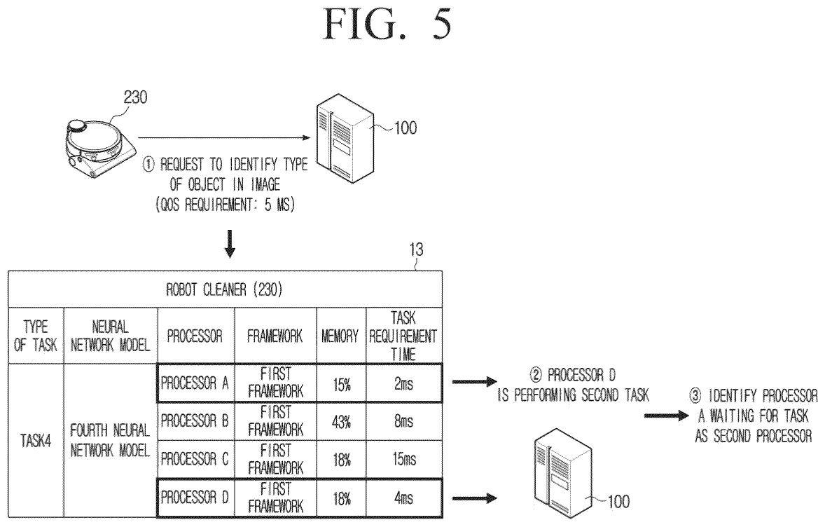

FIG. 5 is an example diagram showing selecting the processor to perform the task on the basis of the quality of service requirement according to an embodiment of the present disclosure.

Referring to FIG. 5, the first processor 131 may be requested by the robot cleaner 230 to perform a task (i.e., Task 4) of identifying the type of object in the image. Here, the first processor 131 may also receive, from the robot cleaner 230, the quality of service requirement set for Task 4 or required for Task 4. As an example, if the robot cleaner 230 requests 5 ms as a response time for Task 4, the first processor 131 may identify the response time of 5 ms as the quality of service requirement for Task 4. That is, the first processor 131 may identify that the task result for Task 4 is required to be transmitted to the robot cleaner 230 within 5 ms from a time point at which Task 4 is requested.

Here, the first processor 131 may identify a fourth neural network model (i.e., neural network model trained to identify the type of object in the image) corresponding to Task 4, and then identify the plurality of profile information corresponding to the identified fourth neural network model. In addition, the first processor 131 may select the second profile information from the plurality of profile information identified based on the quality of service requirement.

In detail, on the basis of the plurality of profile information, the first processor 131 may identify that the quality of service requirement requested by the robot cleaner 230 is unable to be satisfied because the task performance time is 8 ms if the processor B 130-B performs Task 4. In addition, on the basis of the plurality of profile information, the first processor 131 may identify that the quality of service requirement requested by the robot cleaner 230 is unable to be satisfied because the task performance time is 15 ms even if the processor C 130-C performs Task 4.

Accordingly, the first processor 131 may select, as the second profile information, the profile information for the processor A 130-A and a processor D 130-D from four profile information for Task 4. In addition, the first processor 131 may select the second processor to perform Task 4 (i.e., task of identifying the type of obstacle in the image) on the basis of the profile information for the processor A 130-A and the processor D 130-D and the current resource state of the electronic device 100. Here, the first processor 131 may select the processor A 130-A as the second processor if the processor D 130-D is identified as performing a task other than Task 4.

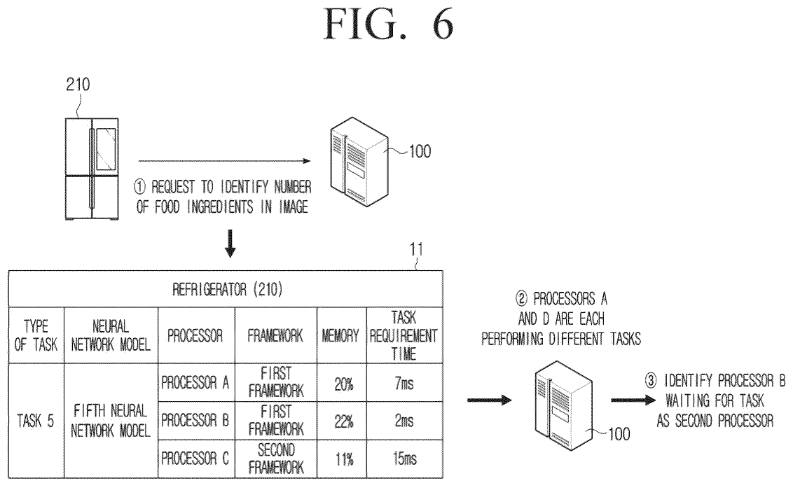

FIG. 6 is an example diagram showing selecting the processor to perform the task on the basis of the resource state of the electronic device 100 according to an embodiment of the present disclosure.

Meanwhile, according to an embodiment of the present disclosure, the first processor 131 may identify, from the plurality of processors 130, the plurality of processors 130 available to perform the task using the first neural network model on the basis of the plurality of profile information, identify the current resource state of the electronic device 100 by identifying whether the identified plurality of processors 130 are performing other previously requested tasks, and identify, from the plurality of processors 130, the second processor to perform the task on the basis of the identified current resource state and plurality of profile information.

In detail, the first processor 131 may identify one or more processors available to perform the task from the plurality of processors 130 based on the plurality of profile information corresponding to the external electronic devices 200 that request the task performance among the plurality of profile information stored in the memory 120.

In addition, the first processor 131 may identify whether a processor performing another task other than the task is present among the identified one or more processors by using current resource state information of the electronic device 100. Another task other than the task may be another task requested before the time point at which the first processor 131 is requested by the external electronic devices 200 to perform the task, and may be a task that is being performed by any one of the plurality of processors 130. Hereinafter, for convenience of the description, the first task refers to the task that the first processor is requested to perform, and a second task refers to another task that is already being performed at the time point at which the first task is requested to be performed.

For example, it may be assumed that the first processor 131 is requested by the refrigerator 210 to perform a task of identifying the number of food ingredients in the image acquired by the refrigerator 210 among the plurality of external electronic devices 200 linked to the electronic device 100 at time point t3. Here, the second task may be the task of voice recognition requested by the speaker 220 if any one of the plurality of processors 130 is performing the task of voice recognition requested by the speaker 220 at time point t2 before the first processor 131 receives the request for the first task. In addition, the first task may be the task of identifying the number of food ingredients in the image requested by the refrigerator 210.

Meanwhile, the above-described example describes that the first task and the second task are different from each other. However, the first task and the second task may be the same task requested by the same external electronic device 200.

In addition, the above-described example describes that the second task is a single task. However, the second task may include a plurality of tasks. For example, to describe again, the second task may include the voice recognition task requested by the speaker 220 and the task of identifying the type of obstacle in the image requested by the robot cleaner 230 if any one of the plurality of processors 130 is requested by the robot cleaner 230 to perform the task of identifying the type of obstacle in the image acquired by the robot cleaner 230 and is performing the task of identifying the type of obstacle at time point t1, which is before time point t3 at which the first processor 131 is requested by the refrigerator 210 to perform the first task in addition to the voice recognition task requested by the speaker 220.

Meanwhile, the first processor 131 may identify, as the second processor to perform the first task, the processor that is not performing the second task from the plurality of processors 130 available to perform the first task identified based on the plurality of profile information corresponding to the first task (or the first neural network model).

In detail, the first processor 131 may identify at least one processor that is not performing the second task from the plurality of processors 130 identified as being available to perform the first task. In addition, the first processor 131 may identify the second processor to perform the first task from at least one identified processor.

Referring to FIG. 6, the first processor 131 may identify a fifth neural network model trained to perform a task (i.e., Task 5) of identifying the number of food ingredients in the image from the plurality of neural network models based on the profile information for the refrigerator 210 if the first processor 131 is requested by the refrigerator 210 to perform the task (e.g., Task 5) of identifying the number of food ingredients in the image.

In addition, the first processor 131 may identify the processor A 130-A, the processor B 130-B, and the processor D 130-D as the processors available to perform the task (i.e., Task 5) of identifying the number of food ingredients in the image using the fifth neural network model based on the profile information corresponding to the fifth neural network model (or Task 5). Here, the first processor 131 may select the processor B 130-B as the second processor to perform Task 5 if the processor A 130-A and the processor D 130-C are identified as performing a task other than Task 5, i.e., second task, on the basis of the current resource state of the electronic device 100.

As described above, according to an embodiment of the present disclosure, the first processor 131 may select the processor that is not performing the task from the plurality of processors 130 and request the task performance. That is, this configuration may prevent the processor that is performing another task from being requested to perform a new task overlapping its task. In this way, the processor may quickly process the tasks requested by the external electronic devices 200, and also perform the plurality of tasks simultaneously, thereby preventing resource overload of the electronic device 100.

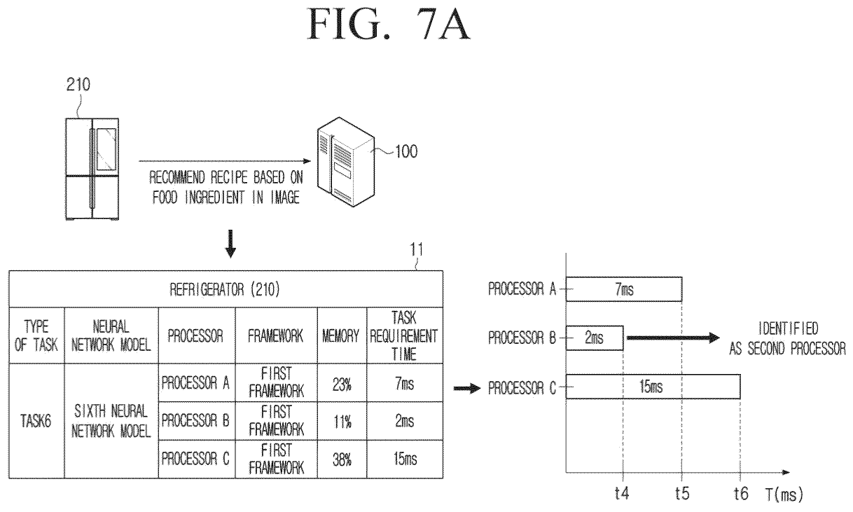

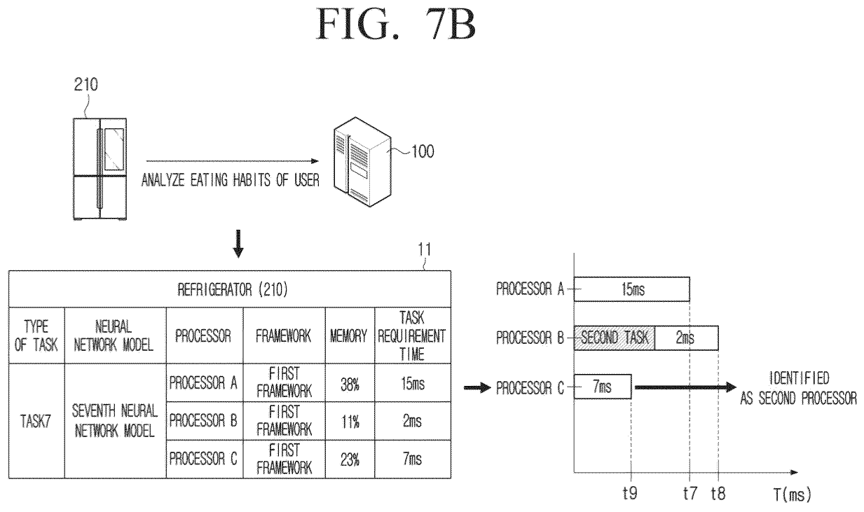

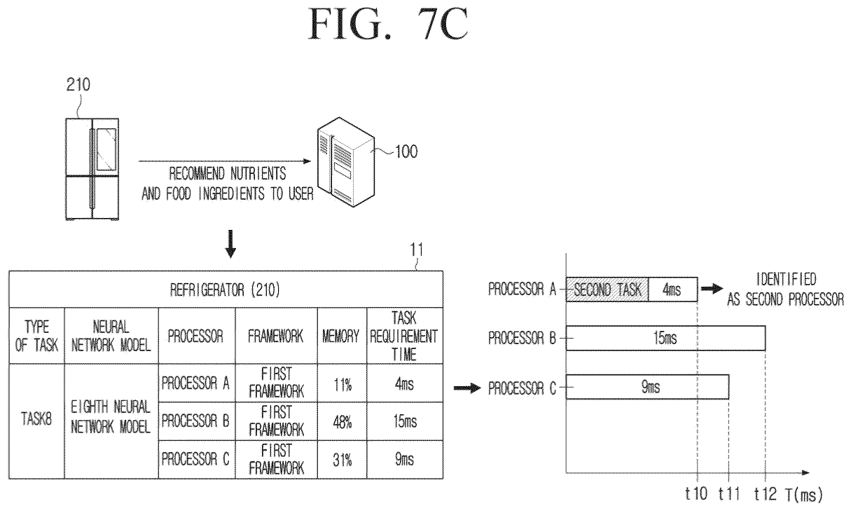

FIGS. 7A, 7B, and 7C are exemplary diagrams showing selecting the processor to perform the task on the basis of a time required for the processor to perform the task according to an embodiment of the present disclosure.

Meanwhile, according to an embodiment of the present disclosure, the first processor 131 may identify a task performance completion time for each of the plurality of processors 130 on the basis of the plurality of profile information, and identify the second processor to perform the task from the plurality of processors 130 based on the identified task performance completion time.

As described with reference to FIG. 3, each of the plurality of profile information may further include time information required for each of the plurality of processors 130 to perform the task using the neural network model. The first processor 131 may identify the plurality of processors available to perform the task based on the plurality of profile information, and identify the time required for each of the identified plurality of processors to perform the task. In this way, the first processor 131 may identify the task performance completion time for each processor. In addition, the first processor 131 may identify the second processor from the plurality of processors on the basis of the identified task performance completion time.

In detail, referring to FIG. 7A, the first processor 131 may be requested by the refrigerator 210 to perform a task (i.e., Task 6) of recommending a recipe on the basis of the food ingredient in the image. In this case, the first processor 131 may identify, from the plurality of neural network models, a sixth neural network model trained to perform the task of recommending a recipe on the basis of the food ingredient in the image, based on the profile information for the refrigerator 210. In addition, the first processor 131 may identify the processor A 130-A, the processor B 130-B, and the processor C 130-C as the processors available to perform Task 6 using the sixth neural network model based on the profile information corresponding to the sixth neural network model (or Task 6).

Here, the first processor 131 may identify the task performance completion time for Task 6 for each of the processor A 130-A, the processor B 130-B, and the processor C 130-C, on the basis of the first profile information. FIG. 7A shows that t4 is the task performance completion time if the first processor 131 requests the processor A 130-A to perform the task, t5 is the task performance completion time if the first processor 131 requests the processor B 130-B to perform the task, and t6 is the task performance completion time if the first processor 131 requests the processor C 130-C to perform the task. Therefore, the first processor 131 may identify the processor B 130-B, which requires the least time to perform the task, i.e., completes the task the fastest, as the second processor to perform the task for Task 6.

Meanwhile, the first processor 131 may identify a first task performance completion time for the processor that is performing the second task on the basis of the second profile information corresponding to the second task and the first profile information corresponding to the first task if the processor that is already performing another task (hereinafter, the second task) other than the task (hereinafter, the first task) requested by the external electronic device is present among the plurality of processors 130 available to perform the task identified on the basis of the profile information. Here, the first processor 131 may select the second processor by comparing the first task performance completion times for the plurality of processors 130 including the processor that is performing the second task.

In detail, referring to FIG. 7B, the first processor 131 may identify the processor A 130-A, the processor B 130-B, and the processor C 130-C as the processors available to perform a task (i.e., Task 7) of analyzing eating habits of the user, which is requested by the refrigerator 210. Here, if the processor B 130-B is identified as performing the second task other than the first task, the first processor 131 may identify the first task performance completion time if the processor B 130-B finishes the second task and then performs the first task.

In detail, the first processor 131 may identify a second task performance completion time for the processor B 130-B based on the second profile information corresponding to the second task (in detail, the profile information for the processor B 130-B for the second task), and identify the first task performance completion time for the processor B 130-B after completing the second task based on the first profile information corresponding to the first task (in detail, the profile information for the processor B 130-B for the first task).

Here, the first processor 131 may identify that t7 is the first task performance completion time if the processor A 130-A performs the first task immediately, t8 is the first task performance completion time if the processor B 130-B completes the second task performance, which is currently being performed, and then performs the first task, and t9 is the first task performance completion time if the processor C 130-C performs the first task immediately. Here, the first processor 131 may select the processor C 130-C, which completes the first task performance the fastest, as the second processor.

In addition, referring to FIG. 7C, the first processor 131 may be requested by the refrigerator 210 to perform a task (i. e., Task 8) of recommending nutrients and the food ingredients required for the user. Here, if the processor A 130-A is identified as already performing a task other than the requested task, the first processor 131 may identify the task performance completion time during which the processor A 130-A finishes the task that is already being performed and then performs Task 8.

In detail, the first processor 131 may identify the second task performance completion time for the processor A 130-A based on the second profile information corresponding to the second task (in detail, the profile information for the processor A 130-A for the second task), and identify the first task performance completion time for the processor A 130-A after completing the second task based on the first profile information corresponding to the first task (in detail, the profile information for the processor A 130-A for the first task).

Here, the first processor 131 may identify that t10 is the first task performance completion time if the processor A 130-A completes the second task performance, which is currently being performed, and then performs the first task, t11 is the first task performance completion time if the processor B 130-B performs the first task immediately, and t12 is the first task performance completion time if the processor C 130-C performs the first task immediately.

Here, the first processor 131 may identify that the processor A 130-A may acquire a first task performance result faster than the processor B 130-B or the processor C 130-C even if the processor A 130-A, which is performing the second task, completes the second task performance and then performs the first task. Accordingly, the first processor 131 may select the processor A 130-A as the second processor.

Hereinafter, the description describes a method of the first processor 131 in the present disclosure for generating the plurality of profile information stored in the memory 120 according to an embodiment.

According to an embodiment of the present disclosure, the first processor 131 may identify each neural network model for performing each task performed by the electronic device 100.

In detail, the first processor 131 may identify, for each of the plurality of external electronic devices 200 linked to the electronic device 100, at least one task to be performed by the electronic device 100 on behalf of each of the external electronic devices 200. In particular, the first processor 131 may receive the information on the external electronic devices 200 (identification information of the external electronic devices 200 and the information on the task to be performed by the electronic device 100 for the external electronic devices 200) if the electronic device 100 and the external electronic devices 200 are initially linked with each other, or if these devices are initially connected via the local network using the communication interface 110. In addition, the first processor 131 may identify each neural network model used to perform each task from the plurality of neural network models stored in the memory 120.

In addition, the first processor 131 may identify each of at least one framework used to execute each neural network model for each of the identified neural network models.

Referring back to FIG. 3, the second neural network model may be used for Task 2 of the refrigerator 210. Here, the first processor 131 may identify the first framework or a second framework as a framework used to execute the second neural network model. Meanwhile, a third neural network model may be used for Task 3 of speaker 220. Here, the first processor 131 may identify the first framework, the second framework, or a third framework as a framework used to execute the third neural network model.

In addition, the first processor 131 may identify, from the plurality of processors 130, at least one processor for executing at least one identified framework.

Referring back to FIG. 3, for the second task of the refrigerator 210, the processor A 130-A may perform Task 2 using the first framework or the second framework among the plurality of frameworks corresponding to the second neural network model. On the other hand, the processor B 130-B among the plurality of processors 130 may perform Task 2 using only the first framework among the plurality of frameworks corresponding to the second neural network model.

In addition, for Task 3 of the speaker 220, the processor A 130-A may perform Task 3 using the first framework, the second framework, or the third framework among the plurality of frameworks corresponding to the third neural network model. In addition, the processor C 130-C among the plurality of processors 130 may perform Task 3 using the first framework, the second framework, or the third framework, like the processor A 130-A. On the other hand, processor B 130-B among the plurality of processors 130 may perform Task 3 using only the first framework.

In this way, the first processor 131 may identify the neural network model used to perform each task or trained for each task and at least one processor available to perform the task using the neural network model. In addition, the first processor 131 may identify at least one framework that may be used by at least one identified processor.

In addition, the first processor 131 may control at least one identified processor to perform the task corresponding to the neural network model identified based on the identified framework. In addition, the first processor 131 may identify the resource of the electronic device 100 that is required while at least one identified processor performs the task.

In detail, the first processor 131 may control at least one processor identified for each task to perform each task by executing the neural network model used to perform each task on the basis of the framework identified for each task. In addition, the first processor 131 may identify the resource of the electronic device 100 that is required while each processor performs each task. Here, the resource of the electronic device 100 may include the capacity of the memory 120 included in the electronic device 100, cache information, or the like as described above.

In addition, the first processor 131 may generate the profile information corresponding to the plurality of neural network models on the basis of information on at least one framework, information on at least one processor, and the resource information of the electronic device 100.

Meanwhile, according to an embodiment of the present disclosure, the first processor 131 may generate the profile information for the newly detected external electronic device 200 each time the new external electronic device 200 linked with the electronic device 100 is detected.

In addition, according to an embodiment of the present disclosure, the first processor 131 may update the profile information stored in the memory 120 by periodically generating the profile information.

Meanwhile, according to an embodiment of the present disclosure, the first processor 131 may identify the quality of service (Qos) requirement corresponding to the task request, identify whether the task performance of the second processor satisfies the quality of service requirement if the second processor completes the task performance using the neural network model, set the reward value to the profile information corresponding to the second processor among the plurality of profile information if the task performance of the second processor is identified as satisfying the quality of service requirement.

In detail, the first processor 131 may identify the quality of service (Qos) requirement corresponding to the first task request received from the external electronic devices 200. The same quality of service requirement may be applied as described in the embodiment of the present disclosure with reference to FIG. 5, and its detailed description is thus omitted.

Meanwhile, the first processor 131 may identify whether the task performance of the second processor satisfies the quality of service requirement if the second processor completes the task performance using the neural network model. For example, if the quality of service requirement is related to the response time, the first processor 131 may identify whether the time required for the second processor to complete the first task performance and then transmit the task result of the first task to the external electronic devices 200 satisfies the response time corresponding to the quality of service requirement.

In addition, the first processor 131 may set the reward value for the profile information corresponding to the second processor among the plurality of profile information if the task performance of the second processor is identified as satisfying the quality of service requirement.

Here, the profile information corresponding to the second processor may be the profile information on the requested task performance of the processor selected as the second processor among the plurality of profile information corresponding to the task that is requested by the external electronic devices 200 to be performed by the first processor 131.

The first processor 131 may apply the reward value to the profile information corresponding to the processor selected as the second processor if the processor selected as the second processor is identified as performing the task by satisfying the quality of service requirement. The first processor 131 may repeat this process each time the first processor 131 performs the task. Accordingly, the reward value may be applied cumulatively to the plurality of profile information.

Therefore, if the first processor 131 is requested by the external electronic devices 200 to perform the task, the first processor 131 may select the second processor from the plurality of processors 130 on the basis of the plurality of profile information corresponding to the requested task, the reward value applied to the plurality of profile information, and the resource state of the electronic device 100.

Meanwhile, the first processor 131 may set the reward value differently based on a quality of service requirement satisfaction level. In detail, the first processor 131 may set the reward value differently on the basis of a difference resulting from a comparison result by comparing the task performance result of the second processor with the quality of service requirement set for the task. As an example, if the quality of service requirement is a predetermined response time, the first processor 131 may calculate the difference between the predetermined response time and the time required for the second processor to perform the task (i.e., time required for the processor to perform the task after being selected as the second processor and transmit the acquired task result to the external electronic device), and then determine the reward value in response to the calculated difference. It is assumed that the second processor satisfies the predetermined response time (i.e., quality of service requirement).

In more detail, it is assumed that the response time of 5 ms is the quality of service requirement corresponding to the first task of the refrigerator 210 among the external electronic devices 200, and 3 ms of time is required for the processor A 130-A to perform the first task. Here, the first processor 131 may identify that the task performance of the processor A 130-A satisfies the quality of service requirement (the response time of 5 ms) on the basis of the task requirement time of the processor A 130-A of 3 ms. In addition, the first processor 131 may apply the reward value (e.g., 2 points) corresponding to the 2 ms of spare time (5 ms minus the task performance requirement time of the processor A 130-A) to the profile information of the processor A 130-A for the first task.

On the other hand, it is assumed that the processor B 130-B requires 4 ms of time to perform the first task. Here, the first processor 131 may identify that the task performance of the processor B 130-B satisfies the quality of service requirement (the response time of 5 ms) on the basis of the task requirement time of the processor B 130-B of 4 ms. Here, the first processor 131 may apply the reward value (e.g., 1 point) corresponding to the 1 ms of spare time (5 ms minus the task performance requirement time of the processor B 130-B) to the profile information of the processor B 130-B for the first task.

In this way, the first processor 131 may apply the reward value differently considering the quality of service requirement satisfaction level in addition to the fact that the task performance of the processor selected as the second processor satisfies the quality of service requirement. The first processor may identify the level to which the second processor satisfies the quality of service requirement in performing the task by considering the resource of the electronic device 100 that is consumed (or utilized) while the second processor performs the task, the task performance time of the second processor, or the like.

Meanwhile, the first processor 131 may evaluate the task performance result of the second processor, identify a grade for the task performance result, and apply the reward value set for the identified grade to the profile information corresponding to the processor selected as the second processor. To describe again the above example, based on a difference between the task requirement time of the second processor and the response time corresponding to the quality of service requirement, the quality of service requirement satisfaction level for the response time may be set as a first grade if the difference is greater than or equal to a predetermined first value, a second grade if the difference is less than the predetermined first value and greater than or equal to a second value, and a third grade if the difference is less than the second value and greater than or equal to 0 (i.e., task requirement time=response time set for the quality of service requirement). Here, the highest reward value may be set to the first grade, and the lowest reward value to the third grade. Meanwhile, the present disclosure is not limited thereto, and the grade for determining the reward value may be set in various numbers and based on various criteria.

Meanwhile, according to the embodiment of the present disclosure described above, the criterion for the reward value is described as the quality of service requirement. However, the reward value may be set using various criteria, such as the type of task, the type of external electronic device requesting the task, and the number of processors available to perform the task.

Meanwhile, according to an embodiment of the present disclosure, the first processor 131 may perform a process of applying the reward value to the plurality of profile information based on reinforcement learning. In detail, the first processor 131 may identify whether the task performance result of the second processor satisfies the quality of service requirement as a state of the reinforcement learning, and identify the action of selecting the second processor based on the plurality of profile information corresponding to the requested task of the first processor 131 as an action of the reinforcement learning. In addition, the first processor 131 may determine whether to grant a reward for the action of the first processor 131 for selecting the second processor based on whether the quality of service requirement is satisfied. Here, the first processor 131 may apply the reward to the profile information corresponding to the processor selected as the second processor.

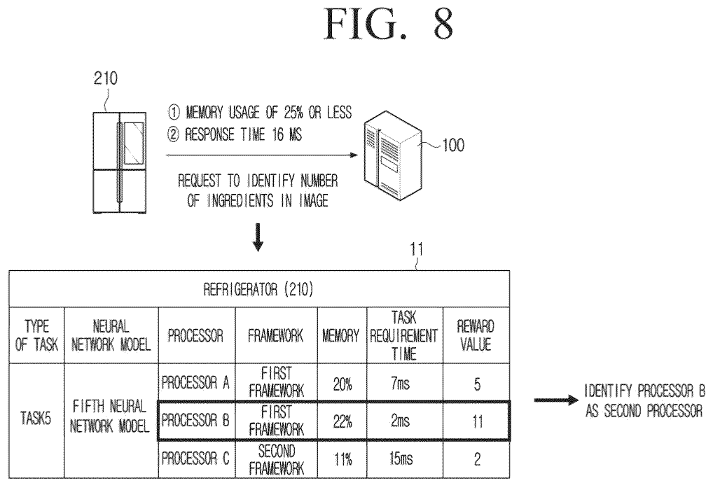

FIG. 8 is an exemplary diagram showing a method for selecting the second processor on the basis of the reward value according to an embodiment of the present disclosure.

Referring to FIG. 8, the first processor 131 may be requested by the refrigerator 210 to perform the task (e.g., Task 5) of identifying the number of food ingredients in the image. Here, the quality of service requirement for Task 5 is to use 25% or less of the memory of the electronic device and transmit a response to the task performance result to the external electronic device within 16 ms.

Here, the plurality of profile information for Task 5 may also include pre-applied reward value information. Here, the pre-applied reward value included in the profile information may be calculated by accumulating the task performance results acquired by each of the plurality of processors (i.e., processor A 130-A, processor B 130-B, and processor C 130-C), which are previously requested by the refrigerator 210 to perform Task 5 repeatedly and perform Task 5 at different time points accordingly. As described above, a task performer of Task 5 may be changed based on the resource state of the electronic device 100, whether the processor is performing another task, or the like, at the time point at which the processor is requested by the refrigerator 210 to perform Task 5. Therefore, all the reward values for the plurality of processors (i.e., processor A 130-A, processor B 130-B, and processor C 130-C) for Task 5 may be calculated. Here, the first processor may select the second processor on the basis of the reward value. Referring to FIG. 8, the reward value of processor B 130-B may be identified as the highest, and the first processor may thus select the processor B 130-B as the second processor and request the processor B 130-B to perform Task 5.

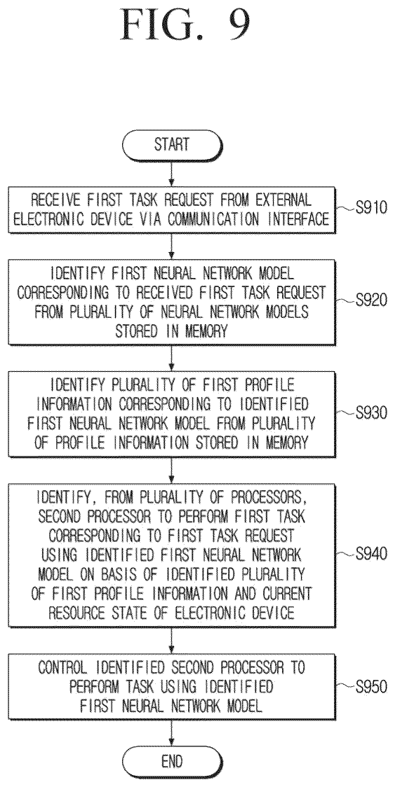

FIG. 9 is a flowchart schematically showing a control method for an electronic device 100 according to an embodiment of the present disclosure.

According to an embodiment of the present disclosure, the first processor 131 among the plurality of processors 130 included in the electronic device 100 may receive the first task request from the external electronic devices 200 via the communication interface 110 of the electronic device 100 (S910), and identify the first neural network model corresponding to the received first task request from the plurality of neural network models stored in the memory 120 of the electronic device 100 (S920).

In addition, the first processor 131 may identify the plurality first profile information corresponding to the identified first neural network model from the plurality of profile information stored in the memory 120 (S930).

Each of the plurality of profile information stored in the memory 120 may include the information on the neural network model for performing the task corresponding to each task request and the resource information of the electronic device 100 that is required for each of the plurality of processors 130 to perform the task using the neural network model.

In addition, the first processor 131 may identify, from the plurality of processors 130, the second processor to perform the first task corresponding to the first task request using the identified first neural network model on the basis of the identified plurality of first profile information and current resource state of the electronic device 100 (S940).

Here, the first processor 131 may identify the plurality of processors 130 available to perform the first task using the first neural network model from the plurality of processors 130 on the basis of the plurality of first profile information. In addition, the first processor 131 may identify the current resource state of the electronic device 100 by identifying, from the identified plurality of processors 130, whether a processor that is performing the second task other than the first task is present. In addition, the first processor 131 may identify, from the plurality of processors 130, the second processor to perform the first task on the basis of the identified current resource state and plurality of first profile information. As an example, the first processor 131 may identify a third processor that is not performing the second task from the identified plurality of processors 130, and identify the identified third processor as the second processor to perform the first task.

Meanwhile, the first processor 131 may identify the second processor, and then control the identified second processor to perform the task using the identified first neural network model (S950).

Meanwhile, according to an embodiment of the present disclosure, at step S830, the first processor 131 may identify the quality of service (Qos) requirement corresponding to the task request, and select the plurality of second profile information satisfying the identified quality of service requirement from the plurality of first profile information. Here, the first processor 131 may identify, from the plurality of processors 130, the second processor to perform the first task using the identified first neural network model on the basis of the plurality of second profile information selected at step S840 and the current resource of the electronic device 100.

Meanwhile, the methods according to the various embodiments of the present disclosure described above may be implemented in the form of an application capable of being installed in a conventional electronic device (e.g., server). Alternatively, the methods according to the various embodiments of the present disclosure described above may be performed using a deep learning-based trained neural network (or deep-learning neural network), that is, the trained network model. In addition, the methods according to the various embodiments of the present disclosure described above may be implemented only by the software upgrade or hardware upgrade of the conventional electronic device. In addition, the various embodiments of the present disclosure described above may also be performed using an embedded server disposed in the electronic device, or a server disposed outside the electronic device.

Meanwhile, according to an embodiment of the present disclosure, the various embodiments described above may be implemented by software including an instruction stored on a machine-readable storage medium (for example, a computer-readable storage medium). A machine may be a device that invokes the stored instruction from the storage medium and may be operated based on the invoked instruction, and may include a display device (e.g., display device A) according to the disclosed embodiments. If the instruction is executed by the function processor, the processor may directly perform a corresponding to the instruction or another component may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)) or online through an application store (for example, PlayStore™). In case of the online distribution, at least portions of the computer program product may be at least temporarily stored on a storage medium such as a memory of a server of a manufacturer, a server of an application store or a relay server, or be temporarily provided.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., modules or programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic device comprising:
a memory configured to store at least one neural network model and a plurality of profile information including at least one profile information corresponding to each of the at least one neural network model; and
a plurality of processors,
wherein each profile information of the plurality of profile information includes information on a neural network model for performing a task corresponding to each task request and information on resource of the electronic device that is required for each processor of the plurality of processors to perform the task using the neural network model, and
wherein a first processor among the plurality of processors is configured to:
receive a first task request;
based on the first task request being received, identify a first neural network model corresponding to the received first task request from the at least one neural network model stored in the memory,
identify at least one first profile information corresponding to the identified first neural network model from the plurality of profile information stored in the memory,
identify, from the plurality of processors, a second processor to perform, by using the identified first neural network model, a first task corresponding to the first task request based on the identified at least one first profile information and a current resource state of the electronic device, and
control the identified second processor to perform, by using the identified first neural network model, the first task.

2. The electronic device as claimed in claim 1, wherein the first processor is configured to:
identify a quality of service (Qos) requirement corresponding to the first task request,
identify at least one second profile information satisfying the identified QOS requirement from the identified at least one first profile information, and
identify, from the plurality of processors, the second processor to perform, by using the identified first neural network model, the first task based on the identified at least one second profile information and a current resource state of the electronic device.

3. The electronic device as claimed in claim 1, wherein the first processor is configured to:
identify, from the plurality of processors, at least one processor available to perform, by using the first neural network model, the first task based on the identified at least one first profile information,
identify the current resource state of the electronic device based on identifying whether each of the at least one processor is performing a second task other than the first task, and
identify, from the at least one processor, the second processor to perform the first task based on the identified current resource state and the identified at least one first profile information.

4. The electronic device as claimed in claim 3, wherein the first processor is configured to:
identify a processor that is not performing the second task from the identified at least one processor as the second processor to perform the first task.

5. The electronic device as claimed in claim 1, wherein the each profile information of the plurality of profile information further includes time information required for the each processor of the plurality of processors to perform, by using the neural network model, the task, and
wherein the first processor is configured to:
identify a performance completion time of the first task for the each processor of the plurality of processors based on the identified at least one first profile information, and
identify, from the plurality of processors, the second processor to perform the first task based on the identified performance completion time.

6. The electronic device as claimed in claim 1, wherein the first processor is configured to:
identify each of the at least one neural network model for performing each task performed by the electronic device,
identify at least one framework used to execute each of the identified at least one neural network model,
identify, from the plurality of processors, at least one processor for executing the identified at least one framework,
obtain information on a resource of the electronic device that is required while each of the identified at least one processor performs each of the task, and
generate each profile information based on information on the at least one framework, information on each of the at least one processor, and information on the resource of the electronic device.

7. The electronic device as claimed in claim 1, wherein the first processor is configured to:
identify a Qos requirement corresponding to the task request,
based on the second processor completes task performance using the neural network model, identify whether the task performance of the second processor satisfies the QOS requirement, and
based on the task performance of the second processor being identified as satisfying the Qos requirement, set a reward value to the identified at least one first profile information corresponding to the second processor among the identified at least one first profile information.

8. The electronic device as claimed in claim 1, wherein the electronic device further comprises a communication interface and is connected to an external electronic device via a local network using the communication interface.

9. A control method for an electronic device, the control method comprising:
based on a first task request, identifying a first neural network model from at least one neural network model stored in a memory of the electronic device;
identifying at least one first profile information corresponding to the identified first neural network model from a plurality of profile information stored in the memory, wherein the plurality of profile information include at least one profile information corresponding to each of the at least one neural network model;
identifying, from a plurality of processors, a second processor to perform, by using the identified first neural network model, a first task corresponding to the first task request based on the identified at least one first profile information and a current resource state of the electronic device; and
controlling the identified second processor to perform, by using the identified first neural network model, the first task,
wherein each profile information of the plurality of profile information includes information on a neural network model for performing a task corresponding to each task request and information on resource of the electronic device that is required for each processor of the plurality of processors to perform the task using the neural network model.

10. The control method as claimed in claim 9, wherein the identifying of the at least one first profile information comprises:
identifying a quality of service (QOS) requirement corresponding to the first task request, and
identifying at least one second profile information satisfying the identified QoS requirement from the identified at least one first profile information, and
wherein the identifying of the second processor comprises:
identifying, from the plurality of processors, the second processor to perform, by using the identified first neural network model, the first task based on the identified at least one second profile information and a current resource state of the electronic device.

11. The control method as claimed in claim 9, wherein the identifying of the second processor comprises:
identifying, from the plurality of processors, at least one processor available to perform, by using the first neural network model, the first task based on the identified at least one first profile information,
identifying the current resource state of the electronic device based on identifying whether each of at least one processor is performing a second task other than the first task, and
identifying, from the at least one processor, the second processor to perform the first task based on the identified current resource state and the identified at least one first profile information.

12. The control method as claimed in claim 11, wherein the identifying of the second processor comprises:
identifying a processor that is not performing the second task from the identified at least one processor as the second processor to perform the first task.

13. The control method as claimed in claim 9, wherein the each profile information of the plurality of profile information further includes time information required for the each processor of the plurality of processors to perform, by using the neural network model, the task, and
wherein the identifying of the second processor comprises:
identifying a performance completion time of the first task for the each processor of the plurality of processors based on the identified at least one first profile information, and
identifying, from the plurality of processors, the second processor to perform the first task based on the identified performance completion time.

14. The control method as claimed in claim 9, further comprising:
identifying each of the at least one neural network model for performing each task performed by the electronic device;
identifying at least one framework used to execute each of the identified at least one neural network model;
identifying, from the plurality of processors, at least one processor for executing the identified at least one framework;
obtaining information on a resource of the electronic device that is required while each of the identified at least one processor performs the task; and
generating each profile information based on information on the at least one framework, information on each of the at least one processor, and information on the resource of the electronic device.

15. The control method as claimed in claim 9, further comprising:
identifying a quality of service (Qos) requirement corresponding to the task request,
based on the second processor completes the task performance using the neural network model, identifying whether the task performance of the second processor satisfies the Qos requirement; and
based on the task performance of the second processor is identified as satisfying the Qos requirement, setting a reward value to the identified at least one first profile information corresponding to the second processor among the identified at least one first profile information.

16. The control method as claimed in claim 9, wherein the electronic device further comprises a communication interface and is connected to an external electronic device via a local network using the communication interface.

17. A non-transitory computer readable recording medium storing computer instructions that cause an electronic device comprising a plurality of processors to perform an operation when executed by a first processor among the plurality of processors, wherein the operation comprises;
based on a first task request, identifying a first neural network model from at least one neural network model stored in a memory of the electronic device;
identifying at least one first profile information corresponding to the identified first neural network model from a plurality of profile information stored in the memory, wherein the plurality of profile information include at least one profile information corresponding to each of the at least one neural network model;
identifying, from the plurality of processors, a second processor to perform, by using the identified first neural network model, a first task corresponding to the first task request based on the identified at least one first profile information and a current resource state of the electronic device; and
controlling the identified second processor to perform, by using the identified first neural network model, the first task,
wherein each profile information of the plurality of profile information includes information on a neural network model for performing a task corresponding to each task request and information on resource of the electronic device that is required for each processor of the plurality of processors to perform the task using the neural network model.

18. The non-transitory computer readable recording medium as claimed in claim 17, wherein the identifying of the at least one first profile information comprises:
identifying a quality of service (Qos) requirement corresponding to the first task request, and
identifying at least one second profile information satisfying the identified Qos requirement from the identified at least one first profile information, and
wherein the identifying of the second processor comprises:
identifying, from the plurality of processors, the second processor to perform, by using the identified first neural network model, the first task based on the identified at least one second profile information and a current resource state of the electronic device.

19. The non-transitory computer readable recording medium as claimed in claim 17, wherein the identifying of the second processor comprises:
identifying, from the plurality of processors, at least one processor available to perform, by using the first neural network model, the first task based on the identified at least one first profile information,
identifying the current resource state of the electronic device based on identifying whether each of at least one processor is performing a second task other than the first task, and
identifying, from the at least one processor, the second processor to perform the first task based on the identified current resource state and the identified at least one first profile information.

20. The non-transitory computer readable recording medium as claimed in claim 19, wherein the identifying of the second processor comprises:
identifying a processor that is not performing the second task from the identified at least one processor as the second processor to perform the first task.
